(19) United States
(12) Patent Application Publication
(10) Pub. No.: US 2020/0391156 A1
(43) Pub. Date: Dec. 17, 2020

(54) WATER TREATMENT TANK AND DESULFURIZATION DEVICE

(71) Applicant: Mitsubishi Hitachi Power Systems, Ltd., Yokohama-shi, Kanagawa (JP)

(72) Inventors: Hideaki Sakurai, Tokyo (JP); Naoyuki Kamiyama, Tokyo (JP); Takashi Kawano, Tokyo (JP); Ryozo Sasaki, Yokohama-shi (JP); Seiji Kagawa, Tokyo (JP)

(73) Assignee: Mitsubishi Hitachi Power Systems, Ltd., Yokohama-shi, Kanagawa (JP)

(21) Appl. No.: 16/971,396

(22) PCT Filed: Jan. 28, 2019
(86) PCT No.: PCT/JP2019/002645

§ 371 Date: Aug. 20, 2020

(30) Foreign Application Priority Data
Feb. 23, 2018 (JP) 2018-030608

(51) Int. Cl. B01D 53/50; B01D 53/78; B01D 53/96; C02F 1/72; B01F 3/04; B01F 5/10

(52) U.S. Cl. CPC B01D 53/50; B01D 53/78; B01D 53/96; C02F 2101/101; B01F 3/0446; B01F 5/10; C02F 1/72

(57) ABSTRACT

A water treatment tank includes: a tank body including a bottom surface extending in a horizontal direction; and an overflow wall installed in the tank body to partition an inside space of the tank body into a seawater intake upstream tank into which treatment water having absorbed sulfur from an exhaust gas is introduced and a seawater intake downstream tank into which treatment water overflowing the seawater intake upstream tank is introduced to flow therein. The treatment water flowing into the seawater intake downstream tank is divided by the overflow wall in the width direction of the overflow wall so as to form a waterfall region and a non-waterfall region.

### TECHNICAL FIELD

The present invention relates to a water treatment tank and a desulfurization device.

Priority is claimed on Japanese Patent Application No. 2018-030608, filed Feb. 23, 2018, the content of which is incorporated herein by reference.

### BACKGROUND ART

Generally, since it is necessary to absorb and remove sulfur dioxide (SO₂) from an exhaust gas discharged from coal-fired boilers and the like, a desulfurization device is provided in a power plant and the like. In the desulfurization device, SO₂ in the exhaust gas is absorbed by an absorption liquid in a desulfurization absorption tower. Particularly, in a seawater desulfurization device that uses seawater as an absorption liquid, used seawater having absorbed SO₂ is oxidized by the contact with a large amount of air in an oxidation tank.

As the desulfurization device, it is well known that one in which a weir (overflow wall) is installed in a water channel so as to supply more air to the used seawater supplied to the oxidation tank, thereby the water passing over the weir is dropped into the tank like a waterfall.

Since the seawater is dropped into the oxidation tank like that, fine air bubbles are supplied to the seawater to promote oxidation (for example, see Patent Document 1).

### CITATION LIST

### Patent Document

Patent Document 1: Japanese Unexamined Patent Application, First Publication No. 2012-115764

### SUMMARY OF INVENTION

### Technical Problem

Incidentally, when the weir is installed in the water channel so that the seawater is dropped into the tank like a waterfall to supply air to the water, it is necessary to secure a sufficient head. However, it is necessary for the water channel to have a sufficient height difference in order to increase the head, but the height difference may be small depending on the construction site of the power plant, so that the head cannot be increased. Thus, there is a need for a method that further enhances oxidation without increasing the head. Particularly, in order to promote oxidation, it is necessary to allow air bubbles to reach a deep area of seawater in the tank.

Here, an object of the present invention is to provide a water treatment tank allowing bubbles generated by overflowing treatment water to reach a deep area of water in a downstream tank so that fine bubbles generated by colliding with a water surface are taken into treatment water in the tank and a desulfurization device using the same.

### Solution to Problem

In order to solve the above-described problems, a water treatment tank of an aspect of the present invention includes: a tank body that includes a bottom surface extending in a horizontal direction; and an overflow wall installed in the tank body to partition an inside space of the tank body into an upstream tank into which treatment water having absorbed sulfur from an exhaust gas is introduced and a downstream tank into which the treatment water overflowing from the upstream tank is introduced to flow therein, wherein the treatment water flowing into the downstream tank is divided by the overflow wall in a width direction of the overflow wall so as to form a waterfall region and a non-waterfall region.

With such a configuration, since the treatment water flows over the overflow wall and drops into the downstream tank so as to be gathered in the waterfall region, the treatment water can reach a deep area of the water in the downstream tank. Accordingly, fine bubbles generated by the collision with the water surface can be taken into the treatment water in the downstream tank.

In order to solve the above-described problems, a water treatment tank of another aspect of the present invention includes: a tank body that includes a bottom surface extending in a horizontal direction; and an overflow wall installed in the tank body to partition an inside space of the tank body into an upstream tank into which treatment water is introduced from sea and a downstream tank into which the treatment water overflowing from the upstream tank is introduced to flow therein, wherein the treatment water flowing into the downstream tank is divided by the overflow wall in a width direction of the overflow wall so as to form a waterfall region and a non-waterfall region.

Further, according to a water treatment tank of the present invention, the overflow wall may include a plurality of protrusions which are formed so as to be separated from each other in a width direction of the overflow wall and which are higher than a water surface of the upstream tank.

In this way, since the plurality of protrusions are formed so as to be separated from each other in the width direction and be higher than the water surface of the upstream tank, the waterfall region and the non-waterfall region can be easily formed by the protrusions.

Further, according to the water treatment tank of the present invention, the overflow wall may include a plurality of gathering portions each formed so that of which a flow passage width gradually is decreased toward a downstream side of the treatment water when viewed from above.

With such a configuration, the waterfall region and the non-waterfall region can be formed without increasing the height of the overflow wall.

Further, according to the water treatment tank of the present invention, at least part of an upper end of the overflow wall may be inclined so as to be lowered toward the downstream side of the treatment water.

With such a configuration, the downward speed vector of the treatment water flowing over the overflow wall can be increased.

Further, the water treatment tank of the present invention may further include a division plate which is installed between an upper end of the overflow wall and a water surface of the treatment water flowing over the overflow wall and which is configured to divide the treatment water into first falling water falling to an upstream side of the downstream tank and second falling water falling to a downstream side of the downstream tank with respect to the first falling water.

With such a configuration, it is possible to increase the number of collision points with the water surface after falling by further dividing the falling water, increase the generation of bubbles, and increase the intake of air into the treatment water.

Further, a desulfurization device of the present invention includes: the water treatment tank; a desulfurization absorption tower which is configured to remove SO₂ in an exhaust gas by absorbing the SO₂ into seawater; and a drainage line which is configured to introduce used seawater discharged from the desulfurization absorption tower into the water treatment tank.

With such a configuration, oxygen can be efficiently supplied to the used seawater. Accordingly, the water treatment tank can be made compact.

### Advantageous Effects of Invention

According to the present invention, since the treatment water flows over the overflow wall and drops into the downstream tank so as to be gathered in the waterfall region so that the treatment water reaches the deep area of the water in the downstream tank, fine bubbles generated by the collision with the water surface can be taken into the treatment water in the downstream tank.

### BRIEF DESCRIPTION OF DRAWINGS

FIG. 1 is a schematic configuration diagram of an embodiment of a desulfurization device according to some embodiments.

FIG. 2 is a perspective view of an embodiment of a seawater intake tank of a first embodiment of the present invention according to some embodiments.

FIG. 3 is a side sectional view of an embodiment of a seawater intake tank overflow tank of the first embodiment of the present invention according to some embodiments.

FIG. 4 is a perspective view showing seawater flowing in the seawater intake tank of an embodiment of the first embodiment of the present invention according to some embodiments.

FIG. 5 is a perspective view of an embodiment of the seawater intake tank of the first embodiment of the present invention according to some embodiments.

FIG. 6 is a plan view of an embodiment of the seawater intake tank of the first embodiment of the present invention according to some embodiments.

FIG. 7 is a perspective view showing seawater flowing in the seawater intake tank of an embodiment of the first embodiment of the present invention according to some embodiments.

FIG. 8 is a side sectional view of an embodiment of the seawater intake tank overflow tank of the first embodiment of the present invention according to some embodiments.

### DESCRIPTION OF EMBODIMENTS

Hereinafter, a desulfurization device according to some embodiments will be described in detail with reference to the drawings.

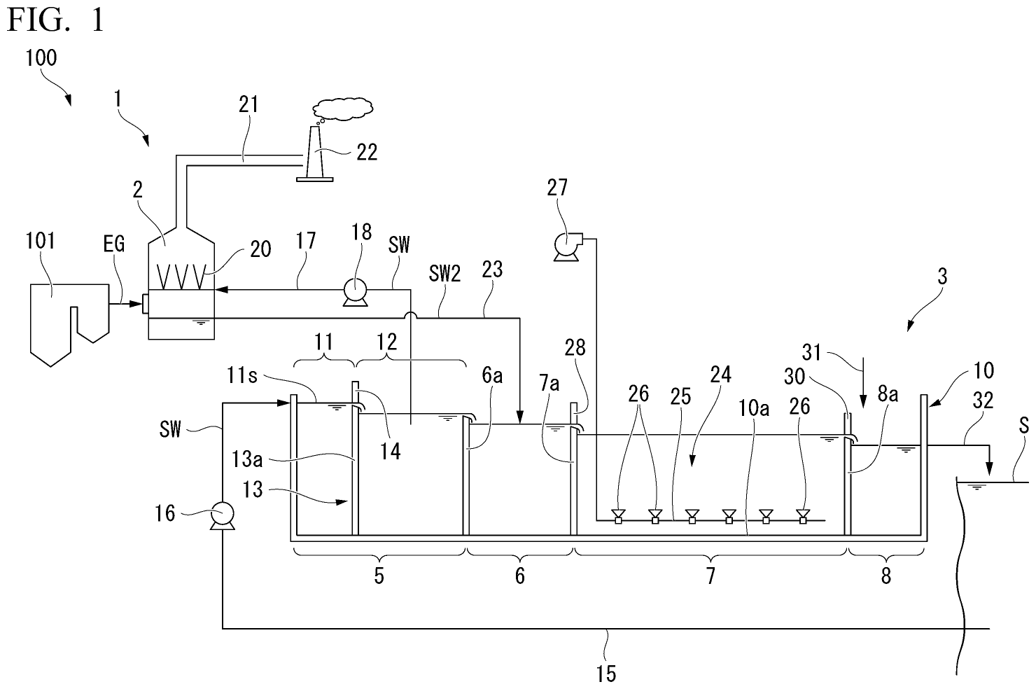

As shown in FIG. 1, a plant 100 including a desulfurization device 1 according to some embodiments includes a coal-fired or heavy oil-fired boiler 101 and a desulfurization device 1.

The desulfurization device 1 includes a desulfurization absorption tower 2 which removes SO₂ (sulfur content) in an exhaust gas EG discharged from the boiler 101 by absorbing it into seawater SW (treatment water) and a water treatment tank 3 which is configured as an oxidation tank 7 or the like for oxidizing used seawater SW2 discharged from the desulfurization absorption tower 2.

The boiler 101 includes a steam turbine driven by steam generated by the boiler 101, a generator that generates power by driving the steam turbine, and the like.

The water treatment tank 3 includes a tank body 10 which includes a bottom surface 10a extending in the horizontal direction and includes a mix tank overflow wall 6a, an oxidation tank overflow wall 7a, a finishing tank overflow wall 8a, and a seawater intake tank overflow wall 13 (weir) which are a plurality of overflow walls defining the tank body 10.

Additionally, in the description below, the mix tank overflow wall 6a, the oxidation tank overflow wall 7a, the finishing tank overflow wall 8a, and the seawater intake tank overflow wall 13 may be simply referred to as the “overflow walls 6a, 7a, 8a, and 13”.

The water treatment tank 3 is partitioned by the overflow wall into a seawater intake tank 5 into which the seawater SW is introduced, a mix tank 6 into which the seawater SW overflowing from the seawater intake tank 5 and the used seawater SW2 having absorbed SO₂ in the desulfurization absorption tower 2 are introduced, the oxidation tank 7 (aeration tank) which oxidizes the seawater SW by the contact with a large amount of air, and a finishing tank 8 (dilution tank) which is disposed at the rear stage of the oxidation tank 7.

Additionally, the height of the bottom surface 10a of the water treatment tank 3 is constant in the entire length in FIG. 1, but the height of the bottom surface 10a of the water treatment tank 3 may be lowered toward the downstream tank.

These tanks are sequentially disposed from the upstream side so as to be adjacent to each other in order of the seawater intake tank 5, the mix tank 6, the oxidation tank 7, and the finishing tank 8. These tanks are configured such that the seawater SW overflowing from the more upstream tank is received by an adjacent downstream tank. That is, the plurality of overflow walls are formed so as to be lowered toward the downstream side.

The seawater intake tank 5 includes the tank body 10, the seawater intake tank overflow wall 13 which divides the inside of the seawater intake tank 5 into the seawater intake upstream tank 11 and the seawater intake downstream tank 12, and the mix tank overflow wall 6a which divides the inside of the seawater intake tank 5 into the seawater intake downstream tank 12 and the mix tank 6.

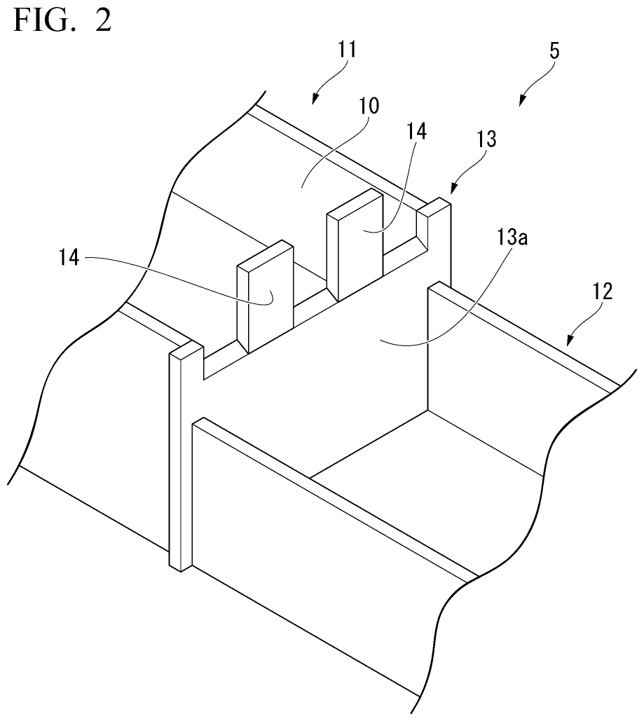

As shown in FIG. 2, the seawater intake tank overflow wall 13 includes a seawater intake tank overflow wall body 13a and a plurality of seawater intake tank protrusions 14 which are higher than a water surface 11s (see FIG. 1) of the seawater intake upstream tank 11. The seawater intake tank protrusions 14 is formed so as to be separated from each other in the width direction of the seawater intake tank overflow wall 13.

The seawater intake tank overflow wall 13 of some embodiments is provided with two seawater intake tank protrusions 14 having a width of about ⅕ of the width of the seawater intake tank overflow wall 13.

The seawater SW does not overflow from the portion provided with the seawater intake tank protrusion 14 and the seawater SW flowing in the seawater intake downstream tank 12 is divided by the seawater intake tank protrusions 14.

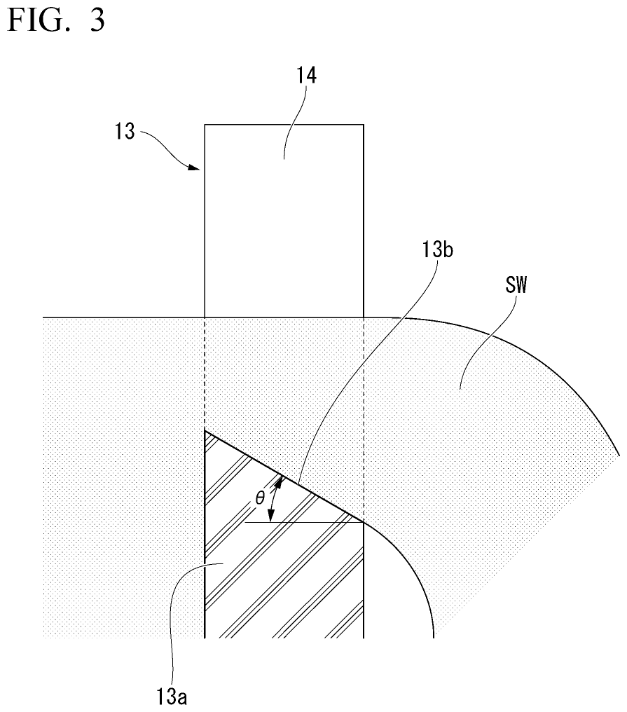

As shown in FIG. 3, the upper end of the seawater intake tank overflow wall body 13a is inclined so as to be gradually lowered toward the downstream side of the seawater SW. That is, the upper end of the seawater intake tank overflow wall body 13a is provided with an inclined surface 13b formed so that the downstream side of the seawater SW is lowered. An angle θ of the inclined surface 13b can be set to, for example, 30° to 45°.

The seawater SW is introduced from the sea which is an external water area into the seawater intake upstream tank 11 through a seawater introduction line 15. The seawater introduction line 15 is provided with a pump 16. The seawater SW flowing over the seawater intake upstream tank 11 is introduced to flow into the seawater intake downstream tank 12. The seawater SW passing over the seawater intake tank overflow wall 13 is dropped into the seawater intake downstream tank 12 so as to be gathered like a waterfall.

The seawater intake downstream tank 12 is provided with a desulfurization seawater line 17 and a pump 18 that send some of the seawater SW to the desulfurization absorption tower 2.

As shown in FIG. 1, a plurality of spray nozzles 20 are provided in the desulfurization absorption tower 2 so as to bring the exhaust gas into gas-liquid contact with the seawater SW as an absorption liquid. An exhaust gas outlet 21 of the desulfurization absorption tower 2 is provided with a chimney 22 for discharging a desulfurized exhaust gas to the atmosphere. A drainage line 23 which sends the used seawater SW2 having absorbed SO₂ discharged from the desulfurization absorption tower 2 to the mix tank 6 is provided between the desulfurization absorption tower 2 and the mix tank 6.

The mix tank 6 includes the tank body 10, the mix tank overflow wall 6a, and the oxidation tank overflow wall 7a which partitions the tank body 10 into the mix tank 6 and the oxidation tank 7. The mix tank 6 is configured to receive the seawater SW overflowing from the seawater intake tank 5 and to introduce the used seawater SW2 discharged from the desulfurization absorption tower 2 thereinto.

The oxidation tank 7 includes the tank body 10, the oxidation tank overflow wall 7a, and the finishing tank overflow wall 8a which partitions the tank body 10 into the oxidation tank 7 and the finishing tank 8. The oxidation tank 7 is configured to receive the seawater SW containing the used seawater SW2 overflowing from the mix tank 6 so that the seawater SW flows from one end to the other end.

The oxidation tank 7 includes a bubble generator 24 which supplies bubbles (air) to the seawater SW in the oxidation tank 7. The bubble generator 24 includes an air supply line 25 which is disposed in a bottom portion of the oxidation tank 7 and a plurality of bubble intake nozzles 26 which are provided in the air supply line 25 and blow out bubbles in multiple stages in the flow direction of the seawater SW. The air supply line 25 is provided with an oxidization air blower 27 which sends air in the atmosphere to the bubble intake nozzle 26.

The configuration of the oxidation tank overflow wall 7a is the same as that of the seawater intake tank overflow wall 13. That is, the oxidation tank overflow wall 7a includes a plurality of oxidation tank protrusions 28. The seawater SW does not overflow from the portion provided with the oxidation tank protrusions 28 and the seawater SW flowing in the oxidation tank 7 is divided by the oxidation tank protrusions 28.

The finishing tank 8 includes the tank body 10 and the finishing tank overflow wall 8a. The finishing tank 8 is configured to receive the used seawater SW2 overflowing from the oxidation tank 7 and to input the seawater SW for diluting the used seawater SW2 through the dilution seawater line 31. The downstream end portion of the finishing tank 8 is provided with a discharge port 32 for discharging the seawater SW.

The configuration of the finishing tank overflow wall 8a is the same as those of the seawater intake tank overflow wall 13 and the oxidation tank overflow wall 7a. That is, the finishing tank overflow wall 8a includes a plurality of finishing tank protrusions 30. The seawater SW does not overflow from the portion provided with the finishing tank protrusion 30 and the seawater SW flowing in the finishing tank 8 is divided by the finishing tank protrusions 30.

Additionally, in the description below, the seawater intake tank protrusion 14, the oxidation tank protrusion 28, and the finishing tank protrusion 30 may be simply referred to as the “protrusions 14, 28, and 30”.

Next, an operation of an embodiment of the desulfurization device 1 according to some embodiments will be described.

In the boiler 101, a steam turbine is driven by using steam and power is generated by a generator. The exhaust gas EG generated from the boiler 101 is introduced into the desulfurization absorption tower 2 and the heated seawater SW is sprayed as the absorption liquid to the exhaust gas EG. Accordingly, SO₂ in the exhaust gas EG is absorbed by the seawater SW and changes into sulfites such as sulfurous acid (H₂SO₃), bisulfite ions (HSO₃⁻), and sulfite ions (SO₃²⁻) in the seawater SW. The exhaust gas EG from which SO₂ is removed is released from the chimney 22 to the atmosphere. The used seawater SW2 having absorbed SO₂ is discharged from the desulfurization absorption tower 2 and is introduced into the mix tank 6 through the drainage line 23.

On the other hand, the seawater SW is introduced into the seawater intake tank 5 disposed at the most upstream side of the water treatment tank 3 through the seawater introduction line 15. The seawater SW is supplied to the desulfurization absorption tower 2 through the desulfurization seawater line 17.

In the mix tank 6, the seawater SW overflowing from the seawater intake tank 5 and the used seawater SW2 discharged from the desulfurization absorption tower 2 are mixed and diluted.

The used seawater SW2 discharged from the desulfurization absorption tower 2 generally has low pH. Thus, this value can be raised to a value (for example, pH6 or more) at which the oxidation reaction proceeds rapidly by the dilution in the mix tank 6.

Further, the used seawater SW2 discharged from the desulfurization absorption tower 2 generally has a high concentration of SO₃²⁻. Thus, the concentration of SO₃²⁻ in the used seawater SW2 can be decreased to a value (for example, 1.2 mmol/liter or less) at which SO₂ does not diffuse into the gas phase due to this dilution. The mixed used seawater SW2 is introduced into the oxidation tank 7 by overflowing from the mix tank 6.

Next, in the oxidation tank 7, an oxygen supply necessary for oxidizing SO₃²⁻ and an oxygen supply necessary for obtaining an oxygen concentration required to be discharged are performed. Specifically, bubbles (air) are blown from the bubble intake nozzles 26 of the bubble generator 24 into the seawater SW (the used seawater SW2) flowing in the oxidation tank 7.

Accordingly, SO₃²⁻ in the used seawater SW2 is oxidized to SO₄²⁻ to be chemically detoxified. The seawater SW which is oxidized in the oxidation tank 7 overflows from the oxidation tank 7 to be introduced into the finishing tank 8.

Next, the seawater SW is put into the used seawater SW2 flowing in the finishing tank 8 through the dilution seawater line 31 so as to dilute the seawater SW. Accordingly, the water quality which can be discharged is obtained. The standard of the water quality that can be discharged depends on the plant, but can be set according to a standard value of pH or dissolved oxygen (DO).

Additionally, the dilution seawater line 31 can be omitted depending on the plant.

In the seawater intake tank 5, fine bubbles are generated when the seawater SW overflowing from the seawater intake tank overflow wall 13 collides with the water surface of the seawater intake downstream tank 12.

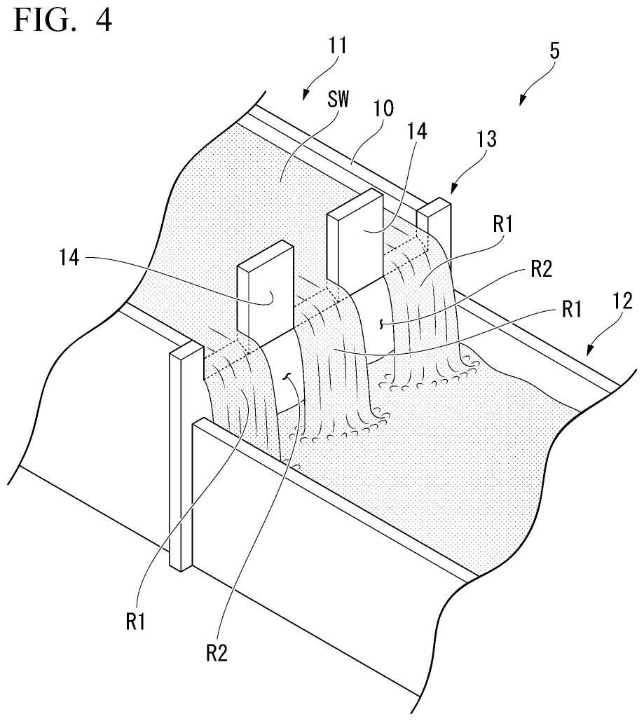

As shown in FIG. 4, in the seawater intake tank overflow wall 13 of the embodiment, since the seawater SW is divided into three by the seawater intake tank protrusions 14, a waterfall region R1 and a non-waterfall region R2 are formed. Since the seawater SW flows over the seawater intake tank overflow wall 13 and drops into the seawater intake downstream tank 12 so as to be gathered in the waterfall region R1, bubbles reach a deep area of the water in the seawater intake downstream tank 12. Accordingly, the dissolved oxygen amount (DO) of the seawater SW in the seawater intake downstream tank 12 is easily saturated.

In the oxidation tank 7, bubbles are generated when the seawater SW overflowing the oxidation tank overflow wall 7a collides with the water surface of the oxidation tank 7. Similarly to the seawater intake tank overflow wall 13, in the oxidation tank overflow wall 7a, since the seawater SW is divided into three by the oxidation tank protrusions 28, a waterfall region and a non-waterfall region are formed. Since the seawater SW flows over the oxidation tank overflow wall 7a and drops into the oxidation tank 7 so as to be gathered in the waterfall region, bubbles reach a deep area of the water in the oxidation tank 7. Accordingly, the oxidization in the oxidation tank 7 is promoted.

Also in the finishing tank 8, similarly to the oxidation tank 7, the seawater SW overflowing the finishing tank overflow wall 8a collides with the water surface so that bubbles are generated. Similarly to the seawater intake tank overflow wall 13, in the finishing tank overflow wall 8a, since the seawater SW is divided into three by the finishing tank protrusions 30, a waterfall region and a non-waterfall region are formed. Since the seawater SW flows over the finishing tank overflow wall 8a and drops into the finishing tank 8 so as to be gathered in the waterfall region, bubbles reach a deep area of the water in the finishing tank 8. Accordingly, finish oxidation before discharge is promoted.

According to some embodiments described above, the seawater SW overflowing the overflow walls 6a, 7a, 8a, and 13 drops down and collides with the water surface in the tank, thereby fine bubbles are generated. Since the seawater SW flows over the overflow walls 6a, 7a, 8a, and 13 and drops into the tank so as to be gathered in the waterfall region R1, the seawater SW can reach the deep areas of the water in the downstream tank. Accordingly, more bubbles can be taken into the seawater SW in the downstream tank.

Further, the waterfall region R1 and the non-waterfall region R2 can be easily formed by the protrusions 14, 28, and 30.

Further, since oxygen can be efficiently supplied to the seawater SW, the oxidation tank 7 can be made compact.

Additionally, in some embodiments described above, the seawater intake tank overflow wall 13, the oxidation tank overflow wall 7a, and the finishing tank overflow wall 8a are provided with the protrusions 14, 28, and 30, but all overflow walls may not be provided with the protrusions. If necessary, the overflow wall provided with the protrusion can be selected.

Hereinafter, an embodiment of the desulfurization device according to some embodiments of the present invention will be described in detail with reference to the drawings. Additionally, in some embodiments, a difference from the embodiment shown in FIG. 2 described above will be mainly described and a description of the same part will be omitted.

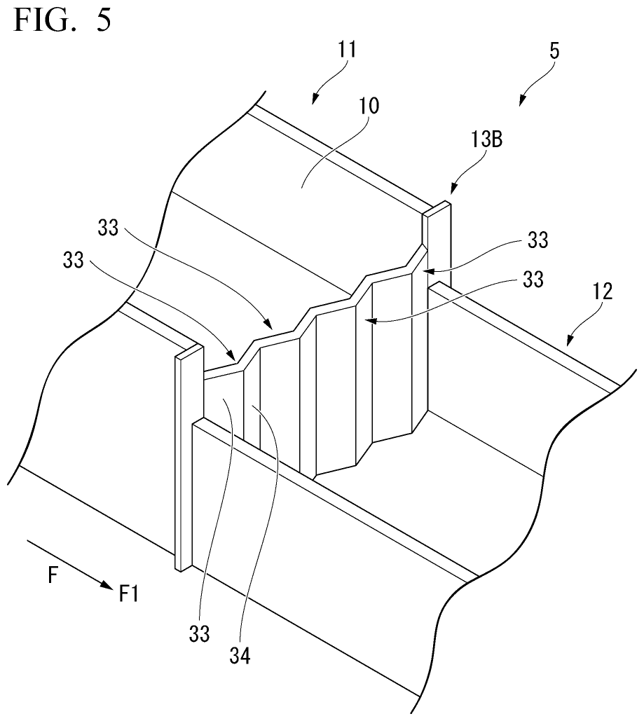

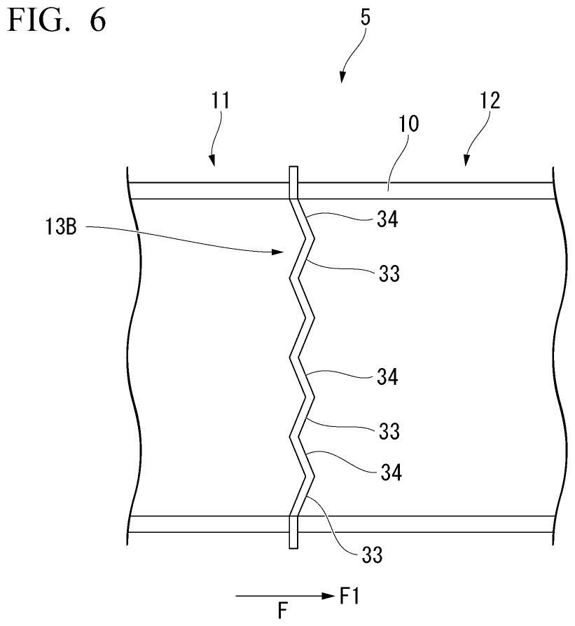

As shown in FIGS. 5 and 6, a seawater intake tank overflow wall 13B of the seawater intake tank 5 according to some embodiments includes a plurality of gathering portions 33 which are each formed so that a flow passage width of them is gradually decreased toward a downstream side F1 of the seawater W. The gathering portion 33 includes a first inclined wall 34 and a second inclined wall 35 which are inclined with respect to the flow direction F of the seawater W.

The gathering portion 33 of the seawater intake tank overflow wall 13B according to some embodiments is formed so that the seawater SW flowing in the gathering portion 33 concentrates in the vicinity of the center of the gathering portion 33 in the width direction.

The first inclined wall 34 and the second inclined wall 35 are plane-symmetric with respect to a vertical plane along the flow direction F of the seawater W. That is, the gathering portion 33 of the seawater intake tank overflow wall 13B according to some embodiments has a V shape that allows the first inclined wall 34 and the second inclined wall 35 to be close to each other toward the downstream side F1 of the seawater W when viewed from above.

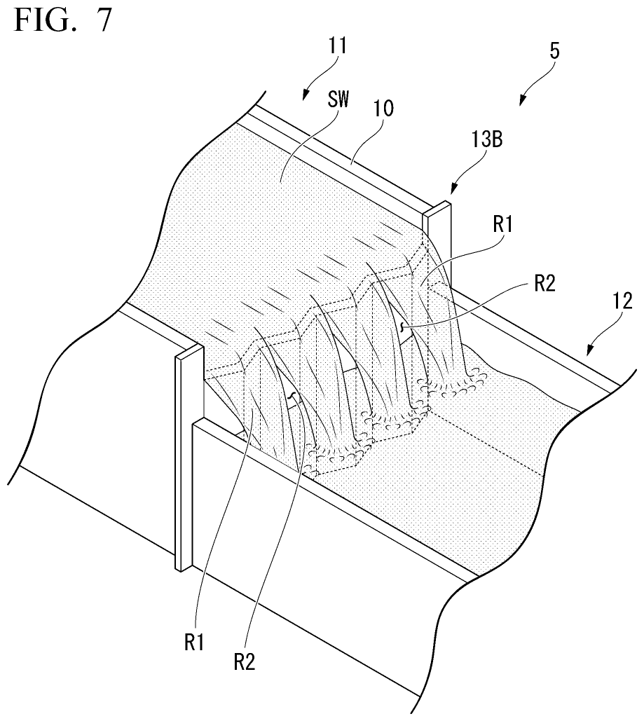

According to the above-described configuration, as shown in FIG. 7, since the seawater SW drops so as to be gathered in the waterfall region R1 by the gathering portion 33, the seawater SW can reach the deep area of the water in the seawater intake downstream tank 12. Accordingly, fine bubbles generated by the collision with the water surface can be taken into the seawater SW in the seawater intake downstream tank 12.

Further, since the seawater SW is gathered by the gathering portion 33, the waterfall region R1 and the non-waterfall region R2 can be formed without increasing the height of the seawater intake tank overflow wall 13.

Additionally, in the above-described configuration, the gathering portion 33 is provided in the seawater intake tank overflow wall 13B, but the oxidation tank overflow wall 7a and the finishing tank overflow wall 8a may be provided with the gathering portion 33.

Hereinafter, an embodiment of the desulfurization device according to some embodiments of the present invention will be described in detail. Additionally, in the embodiment, a difference from the embodiment shown in FIG. 3 described above will be mainly described and a description of the same part will be omitted.

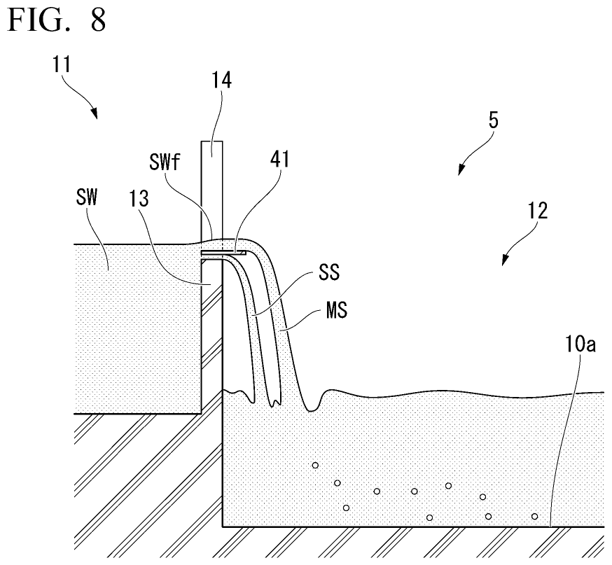

As shown in FIG. 8, the desulfurization device of the embodiment includes a division plate 41 which is disposed between the upper end of the seawater intake tank overflow wall 13 and a water surface SWf of the seawater SW overflowing the seawater intake tank overflow wall body 13a.

The division plate 41 is disposed so as to divide the seawater SW overflowing the seawater intake tank overflow wall body 13a into a small flow rate of a sub-stream SS (first falling water) and a large flow rate of a main stream MS (second falling water). The division plate 41 of the embodiment is disposed so that the seawater SW flowing between the division plate 41 and the upper end of the seawater intake tank overflow wall 13 becomes the sub-stream SS and the seawater SW flowing above the division plate 41 becomes the main stream MS. Accordingly, the sub-stream SS falls to the upstream side of the seawater intake downstream tank 12 and the main stream MS falls to the downstream side of the seawater intake downstream tank 12 with respect to the sub-stream SS. For example, the flow rate of the main stream MS can be set twice the flow rate of the sub-stream SS.

According to the above-described configuration, it is possible to increase the number of the collision points with the water surface after falling by further dividing the seawater SW which is divided by the seawater intake tank protrusions 14, increase the generation of bubbles and increase the intake of air into the seawater SW.

Further, since the flow rate of the main stream MS is set to be larger than the flow rate of the sub-stream SS, bubbles generated by the sub-stream SS can be carried farther by the flow of the main stream MS.

Further, in the above-described configuration, the falling water falling to the upstream side is the sub-stream SS and the falling water falling to the downstream side is the main stream MS, but the present invention is not limited thereto. For example, the falling water falling to the upstream side may be the main stream MS and the falling water falling to the downstream side may be the sub-stream SS. Further, the main stream MS and the sub-stream SS may have the same flow rate. Additionally, the plurality of division plates 41 may be disposed so as to divide falling water into three or more.

Further, in the above-described configuration, the division plate 41 is provided above the seawater intake tank overflow wall body 13a, but the division plate 41 may be provided above the oxidation tank overflow wall 7a or the finishing tank overflow wall 8a.

As described above, an embodiment according to some embodiments of the present invention has been described with reference to the drawings, but the detailed configuration is not limited to the embodiment. Also, modification in design and the like are included in the scope not departing from the spirit of the present invention. Additionally, in some embodiments, the water treatment tank 3 with the protrusion and the gathering portion is applied to the seawater type desulfurization device, but the application thereof is not limited thereto. For example, the water treatment tank 3 using fresh water can be also used.

Further, the protrusion and the gathering portion can be disposed at appropriate positions. For example, a configuration may be employed in which the seawater intake tank overflow wall 13 is provided with the gathering portion and the finishing tank overflow wall 8a is provided with the protrusion.

### INDUSTRIAL APPLICABILITY

The present invention can be applied to the water treatment tank and the desulfurization device.

### REFERENCE SIGNS LIST

1 Desulfurization device
2 Desulfurization absorption tower
3 Water treatment tank
5 Seawater intake tank
6 Mix tank
6a Mix tank overflow wall
7 Oxidation tank
7a Oxidation tank overflow wall
8 Finishing tank
8a Finishing tank overflow wall
10 Tank body
10a Bottom surface
11 Seawater intake upstream tank
12 Seawater intake downstream tank
13, 13B Seawater intake tank overflow wall
13a Seawater intake tank overflow wall body
13b Inclined surface
14 Seawater intake tank protrusion
15 Seawater introduction line
16 Pump
17 Desulfurization seawater line
18 Pump
20 Spray nozzle
21 Exhaust gas outlet
22 Chimney
23 Drainage line
24 Bubble generator
25 Air pipe
26 Bubble intake nozzle
27 Oxidization air blower
28 Oxidation tank protrusion
30 Finishing tank protrusion
31 Dilution seawater line
32 Discharge port
33 Gathering portion
34 First inclined wall
35 Second inclined wall
41 Division plate
100 Plant
101 Boiler
MS Main stream
R1 Water fall region
R2 Non-waterfall region
SS Sub-stream
SW Seawater
SW2 Used seawater

1. A water treatment tank comprising:
a tank body that includes a bottom surface extending in a horizontal direction; and
an overflow wall installed in the tank body to partition an inside space of the tank body into an upstream tank into which treatment water having absorbed sulfur from an exhaust gas is introduced and a downstream tank into which the treatment water overflowing from the upstream tank is introduced to flow therein,
wherein the treatment water flowing into the downstream tank is divided by the overflow wall in a width direction of the overflow wall so as to form a waterfall region and a non-waterfall region.

2. A water treatment tank comprising:
a tank body that includes a bottom surface extending in a horizontal direction; and
an overflow wall installed in the tank body to partition an inside space of the tank body into an upstream tank into which treatment water is introduced from sea and a downstream tank into which the treatment water overflowing from the upstream tank is introduced to flow therein,
wherein the treatment water flowing into the downstream tank is divided by the overflow wall in a width direction of the overflow wall so as to form a waterfall region and a non-waterfall region.

3. The water treatment tank according to claim 1, wherein the overflow wall includes a plurality of protrusions which are formed so as to be separated from each other in a width direction of the overflow wall and which are higher than a water surface of the upstream tank.

4. The water treatment tank according to claim 1, wherein the overflow wall includes a plurality of gathering portions each formed so that of which a flow passage width is gradually decreased toward a downstream side of the treatment water when viewed from above.

5. The water treatment tank according to claim 3, or wherein at least part of an upper end of the overflow wall is inclined so as to be lowered toward the downstream side of the treatment water.

6. The water treatment tank according to claim 1, further comprising a division plate which is installed between an upper end of the overflow wall and a water surface of the treatment water flowing over the overflow wall and which is configured to divide the treatment water into first falling water falling to an upstream side of the downstream tank and second falling water falling to a downstream side of the downstream tank with respect to the first falling water.

7. A desulfurization device comprising:
the water treatment tank according to claim 1;
a desulfurization absorption tower which is configured to remove SO₂ in an exhaust gas by absorbing the SO₂ into seawater; and
a drainage line which is configured to introduce used seawater discharged from the desulfurization absorption tower to the water treatment tank.

8. The water treatment tank according to claim 4, wherein at least part of an upper end of the overflow wall is inclined so as to be lowered toward the downstream side of the treatment water.

9. The water treatment tank according to claim 2, wherein the overflow wall includes a plurality of protrusions which are formed so as to be separated from each other in a width direction of the overflow wall and which are higher than a water surface of the upstream tank.

10. The water treatment tank according to claim 2, wherein the overflow wall includes a plurality of gathering portions each formed so that of which a flow passage width is gradually decreased toward a downstream side of the treatment water when viewed from above.

11. The water treatment tank according to claim 9, wherein at least part of an upper end of the overflow wall is inclined so as to be lowered toward the downstream side of the treatment water.

12. The water treatment tank according to claim 10, wherein at least part of an upper end of the overflow wall is inclined so as to be lowered toward the downstream side of the treatment water.

13. The water treatment tank according to claim 2, further comprising a division plate which is installed between an upper end of the overflow wall and a water surface of the treatment water flowing over the overflow wall and which is configured to divide the treatment water into first falling water falling to an upstream side of the downstream tank and second falling water falling to a downstream side of the downstream tank with respect to the first falling water.

14. A desulfurization device comprising:
the water treatment tank according to claim 2;
a desulfurization absorption tower which is configured to remove SO₂ in an exhaust gas by absorbing the SO₂ into seawater; and
a drainage line which is configured to introduce used seawater discharged from the desulfurization absorption tower to the water treatment tank.
